(19) United States
(12) Patent Application Publication
(10) Pub. No.: US 2020/0332784 A1
(43) Pub. Date: Oct. 22, 2020

(54) DOUBLE-MOTOR DOUBLE-PUMP ELECTRIC DRIVE FRACTURING SEMI-TRAILER

(71) Applicant: YANTAI JEREH PETROLEUM EQUIPMENT & TECHNOLOGIES CO., LTD., Yantai (CN)

(72) Inventors: Rikui Zhang, Yantai (CN); Shuzhen Cui, Yantai (CN); Sheng Chang, Yantai (CN); Shouzhe Li, Yantai (CN); Shitang Liu, Yantai (CN); Xincheng Li, Yantai (CN); Xiance Li, Yantai (CN)

(21) Appl. No.: 16/834,412

(22) Filed: Mar. 30, 2020

(30) Foreign Application Priority Data
Apr. 19, 2019 (CN) 201910319521.6

(51) Int. Cl. F04B 23/04; F04B 17/03; E21B 43/26; F16H 1/06; F16H 1/28; H02K 7/116; H02K 11/04; H02K 11/33

(52) U.S. Cl. CPC F04B 23/04; F04B 17/03; E21B 43/2607; H02K 11/33; F16H 1/28; H02K 7/116; H02K 11/046; F16H 1/06

(57) ABSTRACT

The present invention discloses a double-motor double-pump electric drive fracturing semi-trailer, including a semi-trailer, plunger pumps, radiators, and an electrical control cabinet, and further including electric motors and an inversion unit. The plunger pumps, the radiators, the electrical control cabinet, the electric motors, and the inversion unit are integrated in the semi-trailer. There are two electric motors, two plunger pumps, and two radiators. The inversion unit is disposed on a gooseneck of the semi-trailer. An output terminal of the inversion unit separately drives the two electric motors. The other end of each of the two electric motors is connected to the plunger pump. The radiators cool the lubricating oil in the plunger pump. The electrical control cabinet is used to implement local manipulation of the double-motor double-pump electric drive fracturing semi-trailer. Beneficial effects: An electric motor is used to drive a plunger pump through a transmission shaft, to achieve a small volume, economy, energy conservation, and environmental friendliness. The plunger pumps have improved power compared with a single-pump, and a design of double pumps driven by double electric motors is adopted in entire fracturing equipment, thereby significantly improving the output power of the fracturing equipment and better satisfying the use requirements.

### TECHNICAL FIELD

The present invention relates to the field of fracturing in oil and gas fields, and specifically to a double-motor double-pump electric drive fracturing semi-trailer.

### BACKGROUND

In a configuration mode of a power transmission system used in conventional fracturing equipment on fracturing sites in oil and gas fields all over the world, a diesel engine is connected to a transmission to drive a fracturing plunger pump through a transmission shaft to work. That is, the diesel engine is used as a power source, the transmission and the transmission shaft are used as a transmission apparatus, and the fracturing plunger pump is used as an execution component. This configuration mode has the following disadvantages: (1) Large volume and heavy weight: When the diesel engine drives the transmission to drive the fracturing plunger pump through the transmission shaft, a large volume is occupied, a heavy weight is involved, the transportation is restricted, and the power density is low. (2). Environmental problems: During operation on a well site, the fracturing equipment driven by the diesel engine would generate engine waste gas pollution and noise pollution. The noise exceeding 105 dBA will severely affect the normal life of nearby residents. (3). Cost inefficiency: The fracturing equipment driven by the diesel engine requires relatively high initial purchase costs and incurs high fuel consumption costs for unit power during operation, and the engine and the transmission also require very high routine maintenance costs. Efforts are made globally to manufacture oil and gas exploitation equipment with “low energy consumption, low noise, and low emission”. Therefore, the foregoing disadvantages of the conventional fracturing equipment that uses the diesel engine as the power source impedes the exploitation progress of unconventional oil and gas sources to some extent.

### SUMMARY

To overcome the deficiencies in the prior art, an objective of the present invention is to provide a double-motor double-pump electric drive fracturing semi-trailer. An electric motor is used to drive a plunger pump through a transmission shaft, to achieve a small volume, economy, energy conservation, and environmental friendliness. The plunger pumps have improved power compared with a single-pump, and a design of double pumps driven by double electric motors is adopted in the entire fracturing equipment, thereby significantly improving the output power of the fracturing equipment and better satisfying the use requirements.

The objective of the present invention is achieved by the following technical measures: A double-motor double-pump electric drive fracturing semi-trailer, including a semi-trailer, plunger pumps, radiators, an electrical control cabinet, electric motors, and an inversion unit, wherein the plunger pumps, the radiators, the electrical control cabinet, the electric motors, and the inversion unit are integrated in the semi-trailer; there are two electric motors, two plunger pumps, and two radiators; the inversion unit is disposed on a gooseneck of the semi-trailer, an output terminal of the inversion unit separately drives the two electric motors; the other end of each of the two electric motors is connected to the plunger pump; the radiators cool the lubricating oil in the plunger pumps, and the electrical control cabinet is used to implement local manipulation of the double-motor double-pump electric drive fracturing semi-trailer.

Further, the plunger pumps are five-cylinder plunger pumps. The five-cylinder plunger pump includes a power end assembly, a hydraulic end assembly, and a reduction gearbox assembly, wherein the power end assembly is designed as a segmented structure including a crankcase, a crosshead case, and a spacer frame; one end of the crosshead case is connected to the crankcase through bolts, and the other end of the crosshead case is connected to the spacer frame through bolts; the hydraulic end assembly is disposed at an end of the spacer frame and is connected to the crankcase through bolts sequentially passing through the spacer frame and the crosshead case; the reduction gearbox assembly is connected to the crankcase through bolts, a crankshaft in the crankcase is forged from alloy steel and includes six axle journals and five bellcranks, one bellcrank is disposed between every two adjacent axle journals, and the distance between the center of rotation of the bellcrank and the center of rotation of the crankshaft is 110 mm to 160 mm.

Further, the stroke of the plunger pump is 10″ or above.

Further, the power of the plunger pump is 5000 hp or above.

Further, the reduction gearbox assembly includes a planetary reduction gearbox and a parallel reduction gearbox, the parallel reduction gearbox and the planetary reduction gearbox both employ bevel gear transmission. The planetary reduction gearbox includes one sun gear, four planetary gears, and one gear ring, the four planetary gears form a planetary gear mechanism, the sun gear is located at the center of the planetary gear mechanism, the planetary gears and the adjacent sun gear and gear ring are in a normally engaged state. The parallel reduction gearbox includes a pinion and a bull gear, the pinion is connected to an input end, the bull gear is coaxial with the sun gear of the planetary reduction gearbox, and the reduction gearbox assembly has a transmission ratio of 6.5:1 to 15:1.

Further, the inversion unit has a compartment structure provided with two sets of inverters therein, and the two sets of inverters separately drive the two electric motors to work.

Further, the double-motor double-pump electric drive fracturing semi-trailer is provided with a power generation unit in combination, and the power generation unit is connected to the inversion unit.

Further, the power generation unit includes a power generator and a rectifier, one end of the rectifier is connected to the power generator, and the other end of the rectifier is connected to the inversion unit.

Further, the power generation unit is skid mounted or is semi-trailer mounted.

Further, the number of axles of the semi-trailer is 4 or above.

Compared with the prior art, the beneficial effects of the present invention are as follows:

1. An electric motor is used to drive a plunger pump instead of using an engine and a transmission to drive a plunger pump. A frequency converter is used to implement stepless speed regulation instead of using gear shifting of a transmission to perform speed regulation.

2. A five-cylinder plunger pump with a power density of 5000 hp or above and a stroke of 10″ or above is used to replace an existing electric drive semi-trailer with a power density of 2250 hp.

3. Two inverters, double electric motors, and double pumps with a power of 5000 hp are highly integrated on a gooseneck of one semi-trailer to achieve a pump power up to 10000 hp on a single set of equipment.

4. A power generator (30 MW) and a rectification unit are highly integrated in another semi-trailer. A direct current (DC) voltage obtained after rectification is output to a pump truck. The DC voltage is inverted by an inverter on a gooseneck of the pump truck to directly drive the electric motor, thereby cutting the expenditure on transformer equipment, so that a single power-generator semi-trailer can drive at least three double-motor double-pump electric drive fracturing semi-trailers. Because a transformer is not required, the occupied area, weight, and equipment expenditure of a complete set of fracturing equipment are further reduced.

5. The use of electric drive fracturing equipment greatly improves a single-unit power density, thereby achieving easier arrangement on a well site and more convenient transportation.

6. The use of power driving reduces consumption costs for unit power by approximately 50%.

7. All sets of equipment are integrated in the semi-trailer, thereby achieving easier arrangement on a well site and more convenient transportation.

The present invention will be described in detail below with reference to the accompanying drawings and specific implementations.

### BRIEF DESCRIPTION OF THE DRAWINGS

FIG. 1 is a schematic structural diagram of a double-motor double-pump electric drive fracturing semi-trailer.

FIG. 2 is a schematic component diagram of a single set of electric drive fracturing equipment (60000 hp).

FIG. 3 is a schematic structural diagram of a five-cylinder plunger pump.

FIG. 4 is a schematic structural diagram of a power end assembly in a five-cylinder plunger pump.

FIG. 5 is a schematic diagram of a reduction gearbox assembly in a five-cylinder plunger pump.

FIG. 6 is a sectional view of a five-cylinder plunger pump.

FIG. 7 is a schematic structural diagram of a connecting rod mechanism being connected to a crosshead mechanism in a five-cylinder plunger pump.

FIG. 8 is a schematic structural diagram of a crankshaft in a five-cylinder plunger pump.

FIG. 9 is a schematic structural diagram of a connecting rod bearing bush in a five-cylinder plunger pump.

FIG. 10 is a schematic structural diagram of a parallel reduction gearbox in a five-cylinder plunger pump.

FIG. 11 is a schematic structural diagram of a planetary reduction gearbox in a five-cylinder plunger pump.

Wherein: 1. inversion unit, 2. electric motor, 3. radiator, 4. plunger pump, 5. electrical control cabinet, 6. semi-trailer, 7. power generation unit, 8. power end assembly, 9. hydraulic end assembly, 10. reduction gearbox assembly, 11. crankcase, 12. crosshead case, 13. spacer frame, 14. crankshaft, 15. axle journal, 16. bellcrank, 17. cylindrical roller shaft, 18. valve housing, 19. plunger, 20. bearing seat, 21. front end plate, 22. cover plate, 23. supporting leg, 24. slide rail, 25. support column, 26. connecting rod cap, 27. connecting rod bearing bush, 28. connecting rod body, 29. crosshead, 30. crosshead gland, 31. crosshead connecting screw, 32. crosshead guide plate, 33. guide plate bolt, 34. pull rod, 35. clamp, 36. planetary reduction gearbox, 37. parallel reduction gearbox, 38. flange structure, 39. bull gear, 40. pinion, 41. planetary gear, 42. gear ring, and 43. sun gear.

### DESCRIPTION OF THE EMBODIMENTS

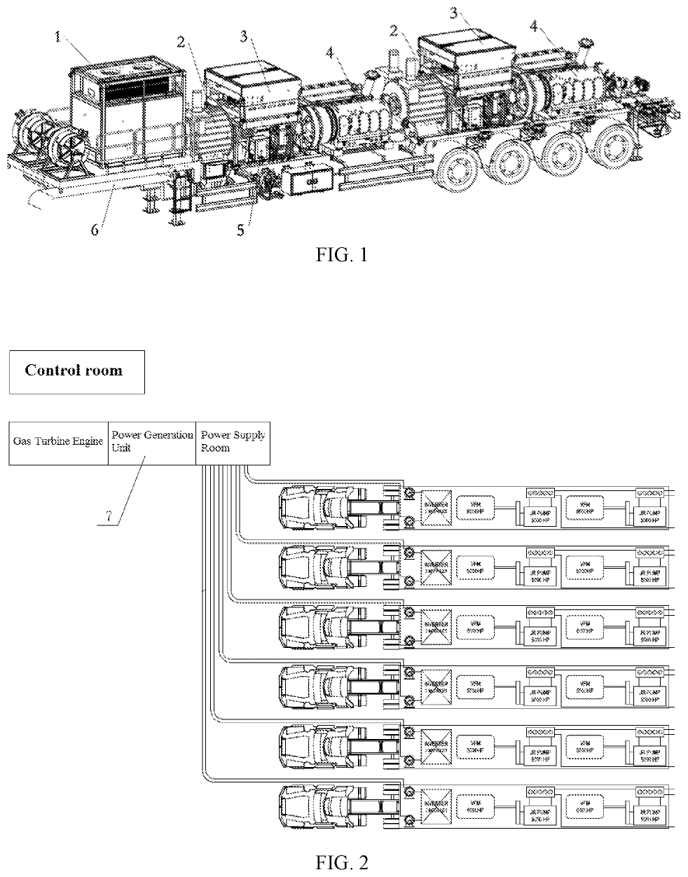

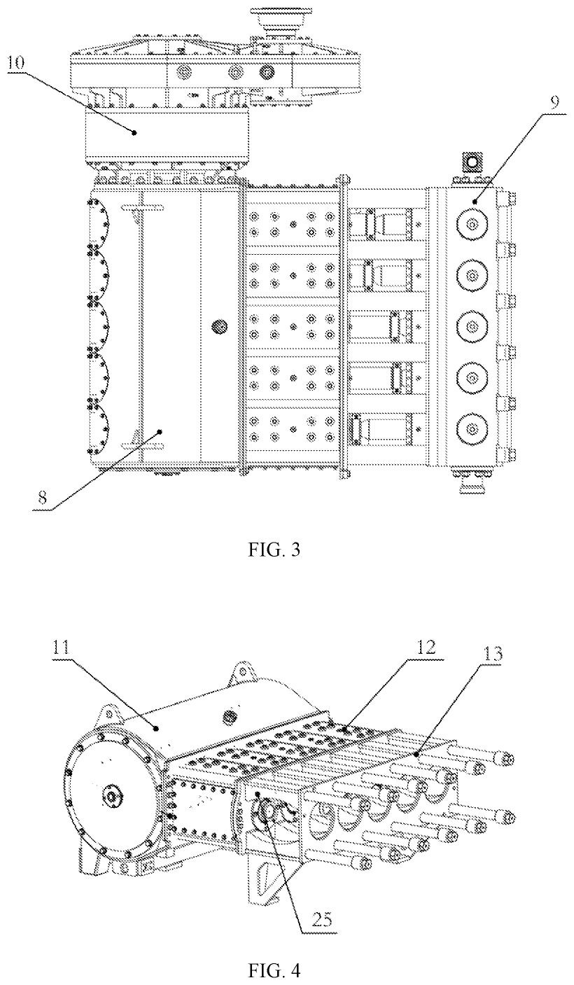

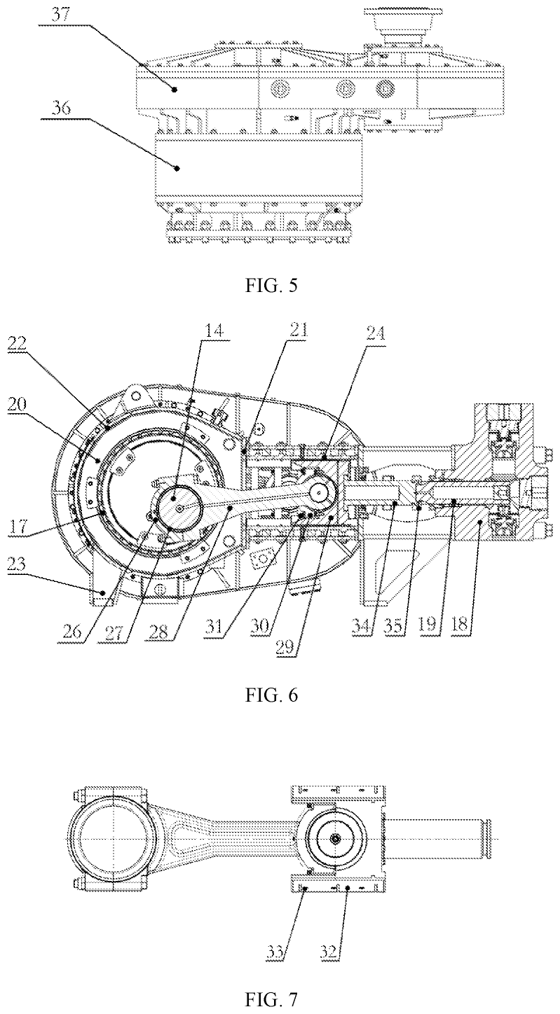

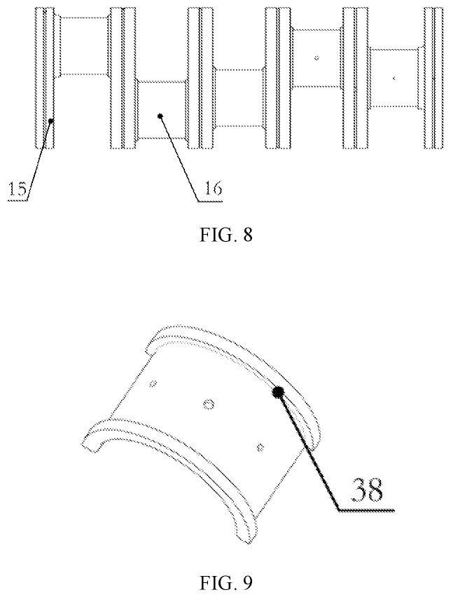

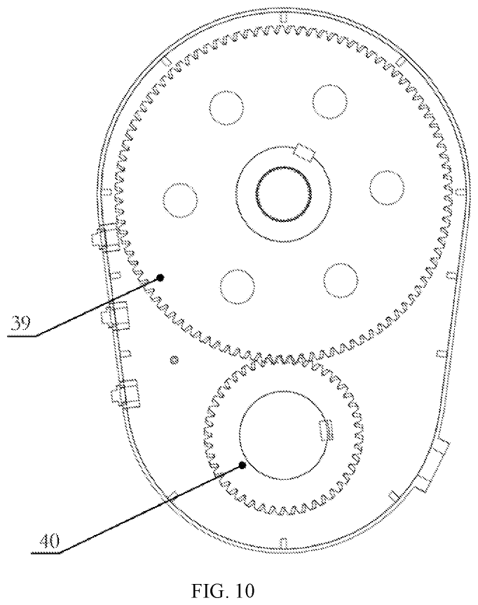

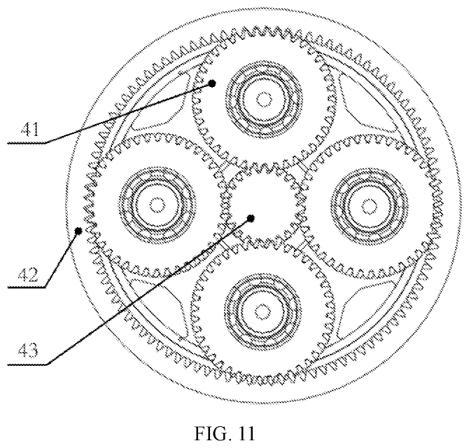

As shown in FIGS. 1 to 11, an embodiment provides a double-motor double-pump electric drive fracturing semi-trailer, including a semi-trailer 6, plunger pumps 4, radiators 3, an electrical control cabinet 5, electric motors 2, and an inversion unit 1. The plunger pumps 4, the radiators 3, the electrical control cabinet 5, the electric motors 2, and the inversion unit 1 are integrated in the semi-trailer 6. The number of axles of the semi-trailer 6 is 4 or above. The inversion unit 1 is disposed on a gooseneck of the semi-trailer 6. One end of the electric motor 2 is connected to the inversion unit 1, and the other end of the electric motor 2 is connected to the plunger pump 4. The radiators 3 cool the lubricating oil in the plunger pumps 4. The electrical control cabinet 5 is used to implement local manipulation of the double-motor double-pump electric drive fracturing semi-trailer. There are two electric motors 2, two plunger pumps 4, and two radiators 3. In the present application, the electric motors 2 and the plunger pumps 4 are appropriately combined, so that the two electric motors 2 and the two plunger pumps 4 can be mounted on the semi-trailer 6. The plunger pump 4 is a five-cylinder plunger pump 4 with a stroke of 10″ or above. The total power of double pumps reaches 10000 hp. The electric motors 2 drive the plunger pumps 4 instead of using an engine and a transmission to drive the plunger pump 4. A frequency converter is used to implement stepless speed regulation instead of using gear shifting of a transmission to perform speed regulation.

The inversion unit 1 has a compartment structure provided with two sets of inverters therein to complete inversion of high-voltage DC electricity into alternating current (AC) electricity. The two sets of inverters separately drive the two electric motors 2 on the semi-trailer 6 to work.

The double-motor double-pump electric drive fracturing semi-trailer is provided with a power generation unit 7 in combination. The power generation unit 7 is connected to the inversion unit 1.

The power generation unit 7 includes a power generator and a rectifier. One end of the rectifier is connected to the power generator, and the other end of the rectifier is connected to the inversion unit 1. The power generator does not need a transformer. A current output by the power generator is rectified to output a DC voltage to the double-motor double-pump electric drive fracturing semi-trailer. The inversion unit 1 on the double-motor double-pump electric drive fracturing semi-trailer then inverts the DC voltage into an AC voltage to drive the electric motor 2. For the power generation unit 7, because a transformer is not required, the occupied area, weight, and equipment expenditure of a complete set of fracturing equipment are further reduced. The power of the power generator is not limited to 30 MW.

The power generation unit 7 is skid mounted or is semi-trailer mounted.

The five-cylinder plunger pump 4 includes a power end assembly 8, a hydraulic end assembly 9, and a reduction gearbox assembly 10. The power end assembly 8 is designed as a segmented structure. In the segmented design, the power end assembly 8 has a compact overall structure and can be processed and manufactured more easily, the assembly and maintenance of the entire pump become more convenient, and the processing costs are reduced at the same time. The power end assembly 8 includes a crankcase 11, a crosshead case 12, and a spacer frame 13. One end of the crosshead case 12 is connected to the crankcase 11 through hexagon bolts, and the other end of the crosshead case 12 is connected to the spacer frame 13 through boltss. The hydraulic end assembly 9 is disposed at an end of the spacer frame 13 and is connected to the crankcase 11 through bolts sequentially passing through the spacer frame 13 and the crosshead case 12. The reduction gearbox assembly 10 is connected to the crankcase 11 through bolts. A crankshaft 14 in the crankcase 11 is forged from alloy steel and includes six axle journals 15 and five bellcranks 16. One bellcrank 16 is disposed between every two adjacent axle journals 15. That is, a five-cylinder structure design is used. The use of the five-cylinder structure design increases an output displacement of the plunger pump. Moreover, compared with a three-cylinder pump, the five-cylinder pump runs stably without vibration, thereby reducing the vibration of the entire pump and extending the service life. The distance between the bellcrank 16 and the center of rotation of the crankshaft 14 is 110 mm to 160 mm, thereby ensuring that the plunger pump can output higher pressure to provide technical support for a long stroke. The stroke of the plunger pump can reach 10 inches. Therefore, a large-displacement work requirement can be implemented. Moreover, the stroke number of the pump is reduced, thereby extending the service life of the components.

The hydraulic end assembly 9 includes a valve housing 18 and a plunger 19. The plunger 19 is disposed in the valve housing 18. The crankcase 11 is formed by welding steel plates, mainly by combining six bearing seats 20, a front end plate 21, a cover plate 22, a supporting leg 23, and the like and welding them together, after then fine finishing the bearing seats 20 and the front end plate 21. The crosshead case 12 is formed by welding steel plates. An arc-shaped slide rail 24 is fixed on the crosshead case 12. The arc-shaped slide rail 24 is forged from alloy steel. The spacer frame 13 is provided with a support column 25 with an arched structure, thereby improving the support strength. Each of the crosshead case 12 and the spacer frame 13 is provided with a through hole. The valve housing 18 is connected to the crankcase 11 through bolts sequentially passing through the spacer frame 13 and the crosshead case 12. The axle journals 15 are provided with a cylindrical roller shaft 17, the outer ring of which is equipped on the bearing seats 20.

A crosshead mechanism is disposed in the crosshead case 12. A connecting rod mechanism is disposed in the crankcase 11 and the crosshead case 12. One end of the connecting rod mechanism is connected to the crankshaft 14, and the other end of the connecting rod mechanism is connected to the crosshead mechanism. The connecting rod mechanism includes a connecting rod cap 26, a connecting rod bearing bush 27, and a connecting rod body 28. The connecting rod cap 26 is connected to the connecting rod body 28 through bolts. The connecting rod bearing bush 27 is located in a cylindrical space formed by the connecting rod cap 26 being connected to the connecting rod body 28. Each of two sides of the connecting rod bearing bush 27 is provided with a flange structure 38. The flange structure has a large width-to-diameter ratio, thereby providing a higher bearing capacity and a desirable positioning effect. The crosshead mechanism includes a crosshead 29, a crosshead gland 30, crosshead connecting screws 31, a crosshead guide plate 32, and a guide plate bolt 33. The connecting rod body 28, the connecting rod cap 26, the crosshead 29, and the crosshead gland 30 are forged from alloy steel. One end of the connecting rod mechanism is connected to the bellcrank 16, and the other end is connected to the crosshead 29 through the crosshead gland 30. The crosshead guide plate 32 is fixed on the crosshead 29 through the guide plate bolts 33. The crosshead guide plate 32 is arc-shaped and has an oil groove on the surface thereof. The crosshead 29 is connected to the plunger 19 of the hydraulic end assembly 9 through a pull rod 34 and a clamp 35. Further, the crosshead 29 is connected to the pull rod 34 through screws.

An output end of the reduction gearbox assembly is connected to the crankshaft 14. The reduction gearbox assembly includes a planetary reduction gearbox 36 and a parallel reduction gearbox 37. The parallel reduction gearbox 37 and the planetary reduction gearbox 36 both employ bevel gear transmission. The planetary reduction gearbox 36 includes one sun gear 43, four planetary gears 41, and one gear ring 42. The four planetary gears 41 form a planetary gear mechanism. The sun gear 43 is located at the center of the planetary gear mechanism. The planetary gears 41 and the adjacent sun gear 43 and gear ring 42 are in a normally engaged state. The parallel reduction gearbox 37 includes a bull gear 39 and a pinion 40. The pinion 40 is connected to an input end. The bull gear 39 is coaxial with the sun gear 43 of the planetary reduction gearbox 36. A rotational speed input at the input end is transferred to the bull gear 39 through the pinion 40 to achieve the first-stage reduction, and the reduced speed is transferred to the sun gear 43 through the bull gear 39 and then transferred to the planetary gears 41 through the sun gear 43 to achieve the second-stage reduction, thereby obtaining a large transmission ratio. The transmission ratio of the reduction gearbox assembly may be up to 6.5:1 to 15:1. The planetary reduction gearbox 36 uses four uniformly distributed planetary gears 41 to transfer both motion and power at the same time. A centrifugal inertia force generated from the revolution of the four planetary gears 41 offsets the radial component of a counterforce between tooth contours, to reduce the force received by the main shaft and achieve high power transmission. A large speed ratio can reduce the input torque and extend the service life of the reduction gearbox, thereby effectively ensuring the matching between turbo-engine drive and electric-motor drive. A large reduction ratio can reduce the stroke number of the plunger pump, and reduce the number of fatigue cycles for various rotary parts, thereby extending the service life of various parts. Moreover, an input angle of the reduction gearbox assembly can be adjusted according to input requirements, thereby satisfying the multi-angle adjustment and adapting various mounting requirements.

It will be appreciated to persons skilled in the art that the present invention is not limited to the foregoing embodiments, which together with the context described in the specification are only used to illustrate the principle of the present invention. Various changes and improvements may be made to the present invention without departing from the spirit and scope of the present invention. All these changes and improvements shall fall within the protection scope of the present invention. The protection scope of the present invention is defined by the appended claims and equivalents thereof.

What is claimed is:

1. A double-motor double-pump electric drive fracturing semi-trailer, comprising a semi-trailer, plunger pumps, radiators, and an electrical control cabinet, and further comprising electric motors and an inversion unit, wherein the plunger pumps, the radiators, the electrical control cabinet, the electric motors, and the inversion unit are integrated in the semi-trailer, there are two electric motors, two plunger pumps, and two radiators, the inversion unit is disposed on a gooseneck of the semi-trailer, an output terminal of the inversion unit separately drives the two electric motors, the other end of each of the two electric motors is connected to the plunger pump, the radiators cool the lubricating oil in the plunger pump, and the electrical control cabinet is used to implement local manipulation of the double-motor double-pump electric drive fracturing semi-trailer.

2. The double-motor double-pump electric drive fracturing semi-trailer according to claim 1, wherein the plunger pumps are five-cylinder plunger pumps, the five-cylinder plunger pump comprises a power end assembly, a hydraulic end assembly, and a reduction gearbox assembly, the power end assembly is designed as a segmented structure comprising a crankcase, a crosshead case, and a spacer frame, one end of the crosshead case is connected to the crankcase through bolts, and the other end of the crosshead case is connected to the spacer frame through bolts, the hydraulic end assembly is disposed at an end of the spacer frame and is connected to the crankcase through bolts sequentially passing through the spacer frame and the crosshead case, the reduction gearbox assembly is connected to the crankcase through bolts, a crankshaft in the crankcase is forged from alloy steel and comprises six axle journals and five bellcranks, one bellcrank is disposed between every two adjacent axle journals, and the distance between the center of rotation of the bellcrank and the center of rotation of the crankshaft is 110 mm to 160 mm.

3. The double-motor double-pump electric drive fracturing semi-trailer according to claim 2, wherein the stroke of the plunger pump is 10″ or above.

4. The double-motor double-pump electric drive fracturing semi-trailer according to claim 3, wherein the power of the plunger pump is 5000 hp or above.

5. The double-motor double-pump electric drive fracturing semi-trailer according to claim 2, wherein the reduction gearbox assembly comprises a planetary reduction gearbox and a parallel reduction gearbox, the parallel reduction gearbox and the planetary reduction gearbox both employ bevel gear transmission, the planetary reduction gearbox comprises one sun gear, four planetary gears, and one gear ring, the four planetary gears form a planetary gear mechanism, the sun gear is located at the center of the planetary gear mechanism, the planetary gears and the adjacent sun gear and gear ring are in a normally engaged state, the parallel reduction gearbox comprises a pinion and a bull gear, the pinion is connected to an input end, the bull gear is coaxial with the sun gear of the planetary reduction gearbox, and the reduction gearbox assembly has a transmission ratio of 6.5:1 to 15:1.

6. The double-motor double-pump electric drive fracturing semi-trailer according to claim 1, wherein the inversion unit has a compartment structure provided with two sets of inverters therein, and the two sets of inverters separately drive the two electric motors to work.

7. The double-motor double-pump electric drive fracturing semi-trailer according to claim 1, wherein the double-motor double-pump electric drive fracturing semi-trailer is provided with a power generation unit in combination, and the power generation unit is connected to the inversion unit.

8. The double-motor double-pump electric drive fracturing semi-trailer according to claim 7, wherein the power generation unit comprises a power generator and a rectifier, one end of the rectifier is connected to the power generator, and the other end of the rectifier is connected to the inversion unit.

9. The double-motor double-pump electric drive fracturing semi-trailer according to claim 7, wherein the power generation unit is skid mounted or is semi-trailer mounted.

10. The double-motor double-pump electric drive fracturing semi-trailer according to claim 1, wherein the number of axles of the semi-trailer is 4 or above.
